(19) United States
(12) Patent Application Publication
(10) Pub. No.: US 2017/0362101 A1
(43) Pub. Date: Dec. 21, 2017

(54) WATER SOFTENER VALVE MECHANISM AND SYSTEM THEREOF

(71) Applicant: Xiamen Runner Industrial Corporation, Xiamen (CN)

(72) Inventors: FENG-SHUN ZHAN, Xiamen (CN); YU-WEI LIAN, Xiamen (CN)

(21) Appl. No.: 15/625,183

(22) Filed: Jun. 16, 2017

(30) Foreign Application Priority Data
Jun. 17, 2016 (CN) 201610426978.3

(51) Int. Cl. C02F 1/42; F16K 31/04; F16K 37/00; F16K 3/02; F16K 11/074; C02F 101/10

(52) U.S. Cl. CPC C02F 1/42; F16K 3/029; F16K 11/074; F16K 31/043; F16K 37/0041; C02F 2201/005; C02F 2209/00; C02F 2303/16; C02F 2101/10; C02F 2303/22

(57) ABSTRACT

A water softener valve mechanism includes a body provided with a main inlet, a main outlet and a discharge. The body has a static valve plate provided with a first passage, a second passage, a third passage, a fourth passage, a blind fifth passage, a sixth passage and a seventh passage and a dynamic plate rotatable relative to the static plate and having an elongated blind hole defined in a side face of the dynamic plate and an aligning hole to selectively communicate with the first passage, the second passage, the third passage and the fourth passage and a driving device mounted inside the body to drive the dynamic valve plate to rotate.

### CROSS REFERENCE

This application claims the priority of Chinese Application No. 201610426978.3, filed on

June 17, 2016 and the entirety thereof is herein incorporated with reference.

### TECHNICAL FIELD

The preferred embodiment of the present invention is related to a field of water softener and, more particularly, to a water softener valve mechanism and system thereof.

### BACKGROUND OF THE INVENTION

Nowadays, the presence of certain metal ions like calcium and magnesium principally as bicarbonates, chlorides, and sulfates in water causes a variety of problems. Hard water leads to the buildup of limescale, which can foul plumbing, and promote galvanic corrosion. In industrial scale water softening plants, the effluent flow from the re-generation process can precipitate scale that can interfere with sewage systems. Water softening is the removal of calcium, magnesium, and certain other metal cations in hard water. The resulting soft water is more compatible with soap and extends the lifetime of plumbing. Water softening is usually achieved using lime softening or ion-exchange resins. Water softeners are well known in the art and typically include a raw water source, a treatment tank containing an ion exchange resin, a brine tank containing a brine solution, and a control valve for directing fluids between the source, the tanks and a drain or other output.

Water softening occurs by running water through the ion exchange resin, which replaces the calcium and magnesium cations in the water with sodium cations. As the ion exchange process continues, the resin eventually loses its capacity to soften water and must be replenished with sodium cations. The process by which the calcium and magnesium ions are removed, the capacity of the ion exchange resin to soften water is restored, and the sodium ions are replenished is known as regeneration.

Periodically, these ion exchange resins must be regenerated. Typically, this regeneration is accomplished utilizing a brine solution such as sodium or potassium chloride. In a typical regeneration process, the brine solution is slowly pumped through the resin bed. Through a chemical exchange process, the calcium and magnesium ions which were adsorbed onto the resin are stripped off and replaced with sodium or potassium ions.

The existing art, for example, U.S. Pat. No. 8,535,540 ('540) describes a control valve device for a water softener and the system thereof, wherein the system includes a piston, wherein movement of the piston between a plurality of different positions is operative to change the flow of water through the orifices.

From the above description abstracted from '540 patent, it is to be noted that the patent is focused on the piston to control open or close of variety of orifices as well as different fluid communication between pipes or conduits.

Another art involving a valve mechanism related to a water softening process is U.S. Pat. No. 8,580,118 ('118). It is noted from the context that this patent is directed to a water softening system, which includes apparatus and process that recycles a substantial percentage of the brine. This system conventionally includes a brine tank and a softening tank through which hard water from a source passes during normal operation. During the regeneration cycle, the brine solution in the brine tank passes through the softening tank acquiring hardness ions, and then through a nano-filter that passes a much higher proportion of the brine ions than the hardness ions. The hardness ions flow from the upstream end of the nano-filter into a drain. The liquid passing through the nano-filter contains salt that returns to the brine tank for reuse.

After study current art, it is noted that numerous valve structures are provided commercially. However, they are either complicated in structure or require additional control modules to control various water softening processes.

### SUMMARY OF THE INVENTION

It is an objective of the preferred embodiment of the present invention to provide a water softener valve mechanism adapted to be in fluid communication with a resin tank containing therein resins for softening hard water and a brine tank containing therein salt water for regenerating resins in the resin tank after a period of time using the resin.

Another objective of the present invention is that the water softener valve mechanism includes a body provided with a main inlet, a main outlet and a discharge. The body further has therein a static valve plate provided with a first passage, a second passage, a third passage, a fourth passage, a blind fifth passage and a sixth passage respectively and radially defined through a surface of the static valve plate and a seventh passage defined through a central portion of the static valve plate to have the first passage, the second passage, the third passage, the fourth passage, the blind fifth passage and the sixth passage radially located around the seventh passage; and a dynamic plate rotatable relative to the static plate and having an elongated blind hole defined in a side face of the dynamic plate to allow a portion of which aligns with the seventh passage and remainder of which to selectively align with the blind fifth passage, the sixth passage, the first passage and the second passage and an aligning hole defined to selectively communicate with the first passage, the second passage, the third passage, the fourth passage and the sixth passage of the static valve plate; and a driving device mounted inside the body to drive the dynamic valve plate to rotate.

Still another objective of the preferred embodiment of the present invention is that the driving device includes a step motor, a master gear securely connected to the step motor to be driven by the step motor to rotate, and a planetary gear meshed with the master gear to be driven by the master gear, the planetary gear is securely connected to the dynamic valve plate to provide a driving force to the dynamic valve plate to rotate relative to the static valve plate to allow the aligning hole to selectively and respectively align with the first passage, the second passage, the third passage, the fourth passage and the sixth passage of the static valve plate.

Still another objective of the preferred embodiment of the present invention is that a plurality photo sensors are mounted inside the body and pads are mounted on the planetary gear to allow the photo sensors to detect angular positions of the dynamic valve plate after rotation.

Still another objective of the preferred embodiment of the present invention is that a water softener valve mechanism is composed of a body having a main inlet, a main outlet, a discharge, a static valve plate immovably located inside the body and having a first passage, a second passage, a third passage, a fourth passage, a blind fifth passage, a sixth passage and a seventh passage radially defined through a face of the static valve plate and a dynamic valve plate rotatable relative to the static plate and having an aligning hole selectively communicating with the first passage, the second passage, the third passage, and the fourth passage and an elongated blind hole with a portion thereof aligned and communicating with the blind fifth passage, the sixth passage, the first passage, and the second passage while the other portion of which is aligned and communicating with the seventh passage of the static valve plate such that filtering phase, reverse phase, regenerating phase, cleansing phase and water supplementing phase are respectively processed via the correlation between the static valve plate and the dynamic valve plate.

Still another objective of the preferred embodiment of the present invention is that a driving device mounted inside the body to drive the dynamic valve plate to move.

Still another objective of the preferred embodiment of the present invention is that the driving device includes a step motor, a master gear securely connected to the step motor to be rotatable relative to the step motor, and a planetary gear meshed with the master gear to be driven by the master gear, the planetary gear is securely connected to the dynamic valve plate to provide a driving force to the dynamic valve plate to rotate relative to the static valve plate.

Still another objective of the preferred embodiment of the present invention is that the dynamic valve plate is rotated to a position to undergo a filtering phase, where the aligning hole is aligned and communicating with the first passage of the static valve plate and the elongated blind hole is aligned with the fifth passage of the static valve plate such that water from a main inlet is flowing through the aligning hole of the dynamic valve plate for entering a resin tank.

Still another objective of the preferred embodiment of the present invention is that the dynamic valve plate is rotated to a position to undergo a reverse cleaning phase, where the aligning hole is aligned with the second channel of the static valve plate and the elongated blind hole is aligned with the sixth channel.

Still another objective of the preferred embodiment of the present invention is that the dynamic valve plate is rotated to a position where the aligning hole aligns with the third passage and the elongated blind hole is aligned with the first passage.

Still another objective of the preferred embodiment of the present invention is that the dynamic valve plate is rotated to a position where the aligning hole aligns and communicates with the third passage and the elongated blind hole is aligned with the first passage.

Still another objective of the preferred embodiment of the present invention is that the dynamic valve plate is rotated to a position where t the aligning hole is aligned and communicating with the fourth passage and the elongated blind hole is on top of the second passage.

### BRIEF DESCRIPTION OF THE DRAWINGS

FIG. 1 is a schematic perspective view of the water softener valve mechanism constructed in accordance with the preferred embodiment of the present invention;

FIG. 2 is a top plan view showing arrangement of the driving device inside the valve body;

FIG. 3 is a top plan view of the static valve plate of the preferred embodiment of the present invention;

FIG. 4 is a top plan view of the dynamic valve plate of the preferred embodiment of the present invention;

FIG. 5 is a schematic cross sectional view showing the movement of fluid inside a water softener in a filtration process;

FIG. 6 is a cross sectional view according to line A-A of FIG. 5;

FIG. 7 is a schematic top plan view showing the cooperation between the static valve plate and the dynamic valve plate in the filtration process in the preferred embodiment of the present invention;

FIG. 8 is a schematic side plan view showing the fluid movement in the filtration process of the preferred embodiment of the present invention;

FIG. 9 is a schematic top plan view showing the cooperation between the static valve plate and the dynamic valve plate in the filtration process in the preferred embodiment of the present invention;

FIG. 10 is a schematic side view showing the fluid movement corresponding to the reverse process in the preferred embodiment of the present invention;

FIG. 11 is a schematic side plan view showing another view of the reverse process in the preferred embodiment of the present invention;

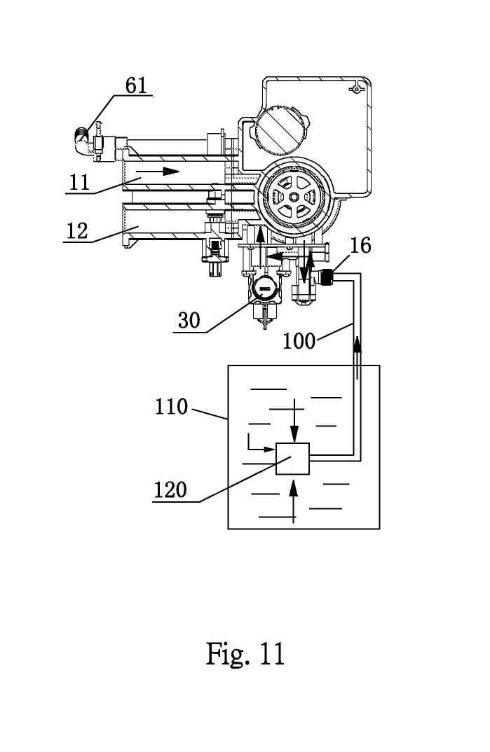

FIG. 12 is a top plan view showing the correlation between the static valve plate and the dynamic valve plate in the regeneration process in the preferred embodiment of the present invention;

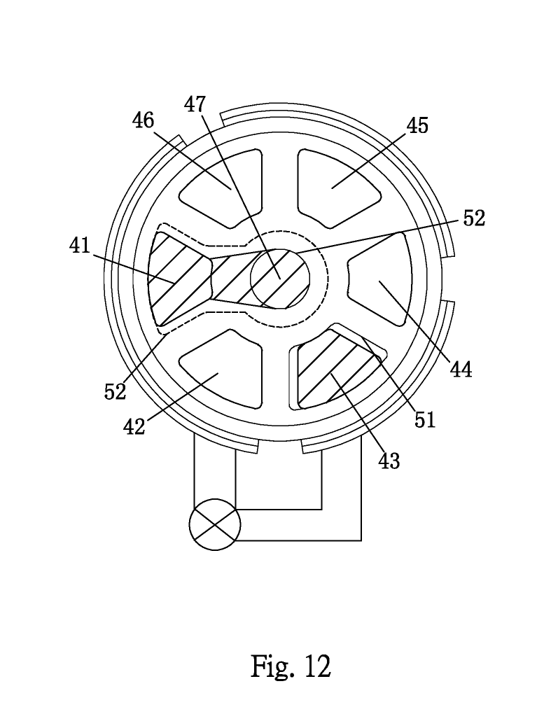

FIG. 13 is another side plan view showing the fluid movement in the water supplementing process in the preferred embodiment of the present invention;

FIG. 14 is a top plan view showing the correlation between the static valve plate and the dynamic valve plate in the water supplementing process in the preferred embodiment of the present invention;

FIG. 15 is a schematic side plan view showing the fluid movement in the cleansing process in the preferred embodiment of the present invention; and

FIG. 16 is a schematic top plan view showing the correlation between the static valve plate and the dynamic valve plate in the cleaning process in the preferred embodiment of the present invention.

### DETAILED DESCRIPTION OF THE PREFERRED EMBODIMENT

Preferred embodiment(s) of the present invention in combination with the attached drawings shall be provided in detail in the following description. However, the given description is for example purpose only and should not be deemed as a limiting to the scope of the present invention in any way.

In order to make it easy to carry out the preferred embodiment of the present invention, a detailed description of the parts of the invention, supported with figures is provided here. As each part of the preferred embodiment of the present invention has many features, it is made easy to read, by referring to each feature with a number included in the parts description text. The number of the parts feature(s) is indicated here by starting it sequentially from the number 10, wherever a part feature appears in a text, an associated serial number is directly assigned.

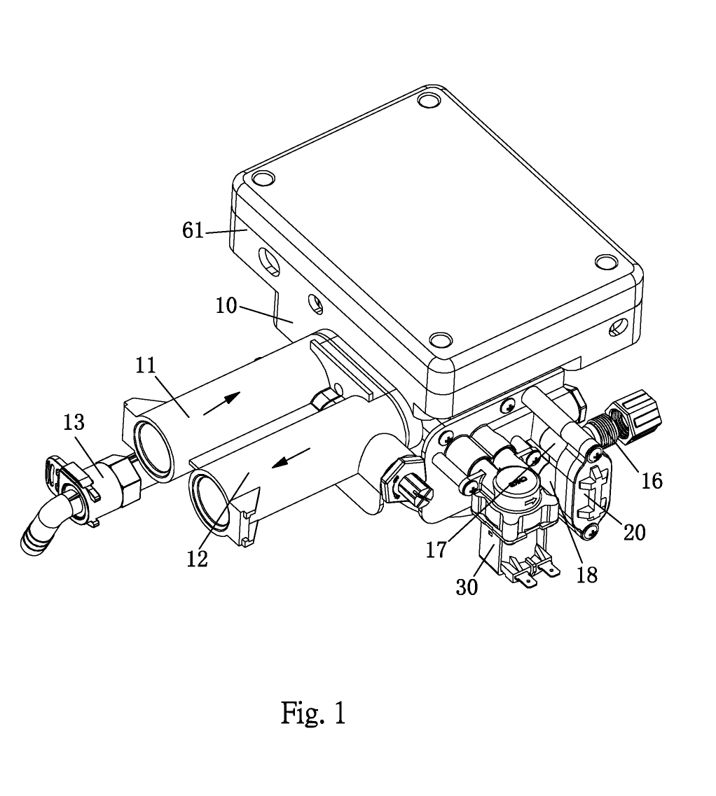

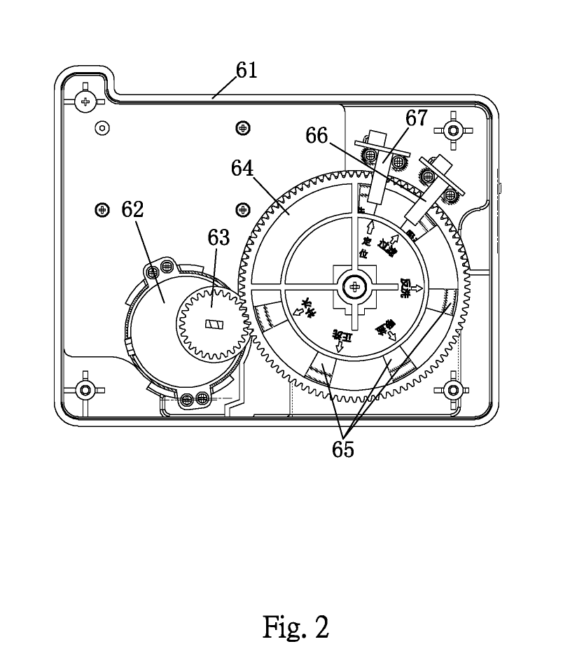

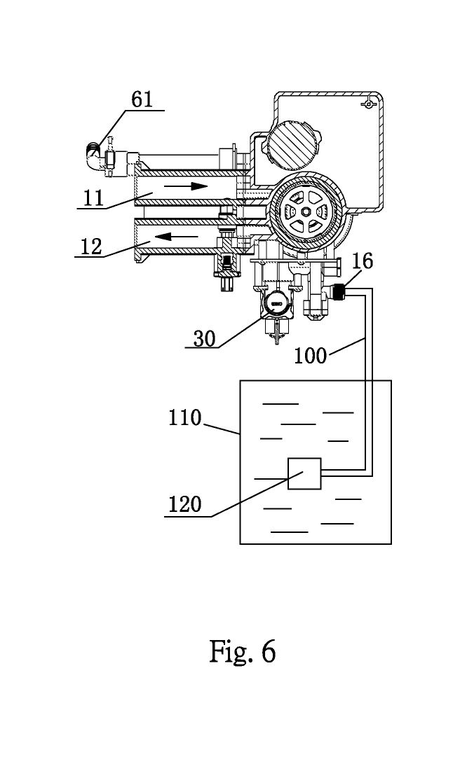

With reference to FIGS. 1, 2, 3, 4 and 5, the water softener valve mechanism constructed in accordance with the present invention has a body 10 provided with therein a main inlet 11, a main outlet 12 and a discharge 13 respectively and laterally extending out from the body 10. The body 10 of the valve mechanism of the preferred embodiment of the present invention further has an outer channel 14 and an inner channel 15 longitudinally extending from a bottom of the body 10. The water softener valve mechanism is adapted to connect to a resin tank 70 and has an ejector 20 adapted to connect to a brine tank 110 (shown in FIG. 6) having salt water therein. The ejector 20 has a salt inlet 16, an ejection inlet 17 and an ejection outlet 18. Still, an electromagnetic valve 30 is provided alongside the ejector 20.

In addition, a static valve plate and a dynamic valve plate 50 are provided inside the body 10 of the water softener valve mechanism of the preferred embodiment of the present invention. The dynamic valve plate 50 is rotatably operative relative to the static valve plate so as to channel different waterways to process different phases of the water softening. Furthermore, to drive the dynamic valve plate 50 to rotate according to different requirements in various water softening phases of the water softener, a step motor 62 is provided inside the body 10 to drive a master gear 63 which is meshed with a planetary gear 64. The planetary gear 64 has an axis 68 connected to the dynamic valve plate 50 such that operation of the step motor 62 is able to drive the dynamic valve plate 50 to rotate accordingly. Still, inside the body 10, there are provided with first photo sensors 66, second photo sensors 67 respectively located inside different locations inside the body 10 and optical sensitive pads 65 are spatially separated from each other and mounted on a face of the planetary gear 64 such that when the planetary gear 64 is rotated due to the operation of the step motor 62 and both the first photo sensors 66 and the second photo sensors 67 detect the angular position of the planetary gear 64 via the pads 65, the valve mechanism of the preferred embodiment of the present invention is ready for a filtering process. Thereafter, by way of the operation of the step motor 62, different waterways can be channeled to undergo different processes.

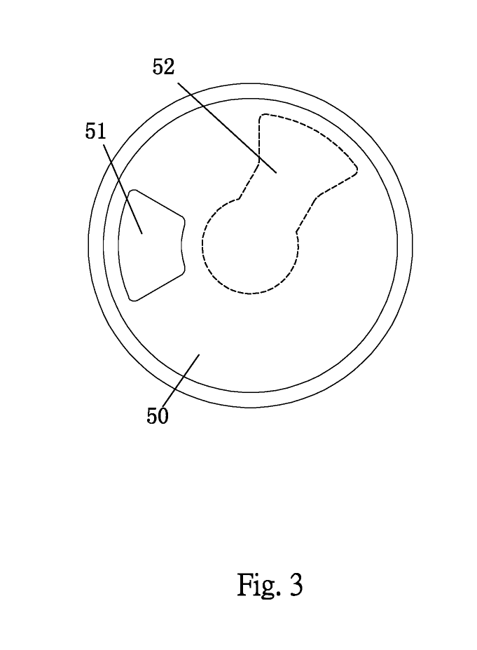

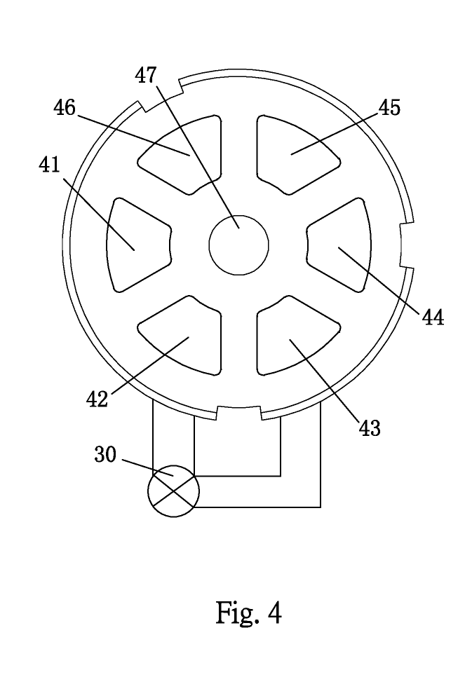

Referring especially to FIGS. 3 and 4, it is noted that the static valve plate could be in any shape. The static valve plate has a first passage 41 defined to selectively communicate with the outer channel 14, a second passage 42 defined to selectively communicate with the inner channel 15, the main outlet 12 and the electromagnetic valve 30, a third channel second 43 defined also to selectively communicate with the salt inlet 16 and the ejection inlet 17, a fourth channel 44 defined to selectively communicate with the outer channel 14, a fifth passage 45 being a closed channel, a sixth channel 46 defined to selectively communicate with the outer channel 14 and a seventh channel 47 communicating with the discharge 13. The dynamic valve plate 50 has an aligning hole 51 defined to selectively align with different passages of the static valve plate and an elongated blind hole 52 defined to selectively align with different passages of the static valve plate.

In the preferred embodiment of the present invention, it is noted that the dynamic valve plate 50 is provided on top of the static valve plate and both are made of ceramic material to reduce the possibility of bacteria existence. Still, the outer channel 14 as well as the inner channel 15 is provided below the body 10 for connection and communication with a resin tank 70. The outer channel 14 is connected to and communicating with an interior of the resin tank 70 and the inner channel 15 is connected to and communicating with a central tube 80 extending into the interior of the resin tank 70. The resin tank 70 has therein resin 71 and quartz sand 72. A free end of the central tube 80 is then provided with a distributor 81. The body 10 further has an outer threading 19 formed for connection to different tanks and a cap 90 provided below the outer threading 19.

Furthermore, it is understood that there are filtering phase, reverse cleaning phase, regenerating phase, cleaning phase and water supplementing phase in a water softener. The following description is aimed at providing a detailed operational process of the relationship between the static valve plate and the dynamic valve plate 50 as well as the waterways in the valve mechanism of the preferred embodiment of the present invention.

Filtering Phase (with the Electromagnetic Valve Off):

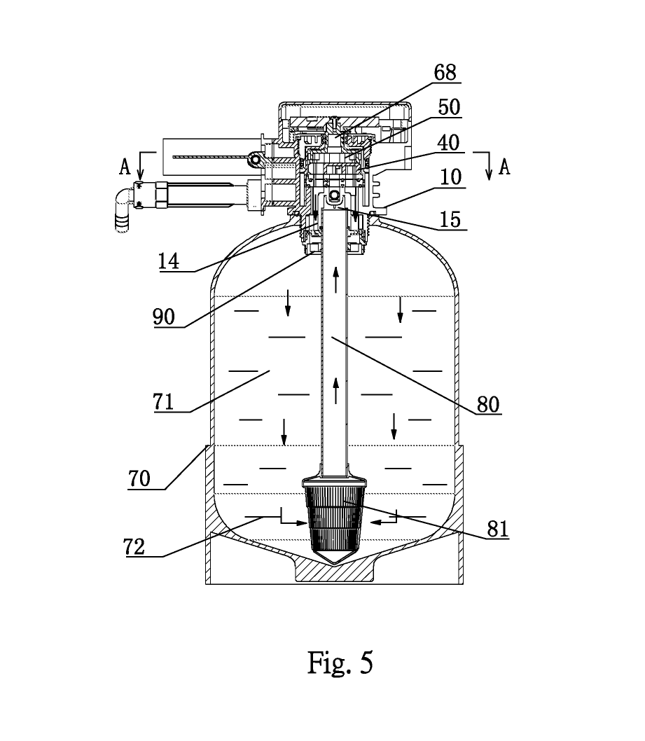

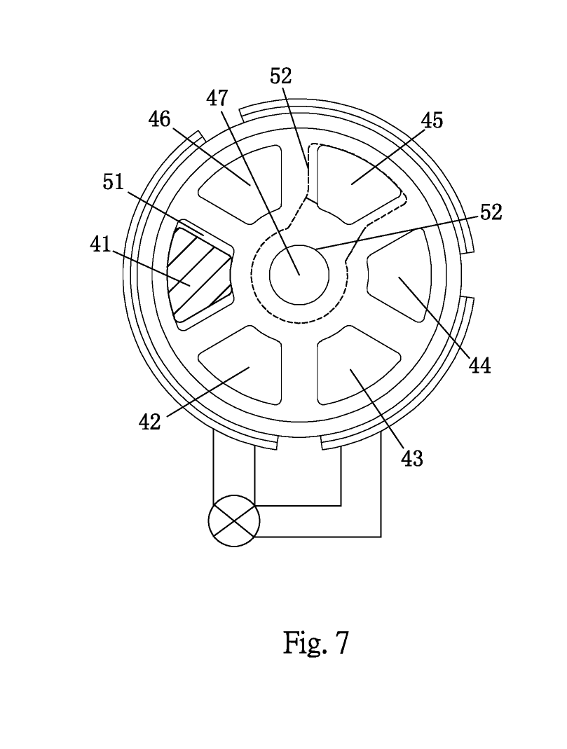

With reference to FIGS. 5, 6 and 7, when the valve mechanism of the embodiment of the present invention is in a filtering phase, the dynamic valve plate 50 is rotated via the driving device to a position where the aligning hole 51 is aligned and communicating with the first passage 41 of the static valve plate and the elongated blind hole 52 is aligned with the fifth passage 45 of the static valve plate. In this status, water from the main inlet 11 is flowing through the aligning hole 51 of the dynamic valve plate 50 and the outer channel 14 to directly enter the resin tank 70. After being filtered by the resin 71 and the quartz sand 72, the filtered water flows via the assistance of the distributor 81 as well as the central tube 80 to the inner channel 15 and out of the valve mechanism from the main outlet 12.

Reverse Cleaning (with the Electromagnetic Valve Off)

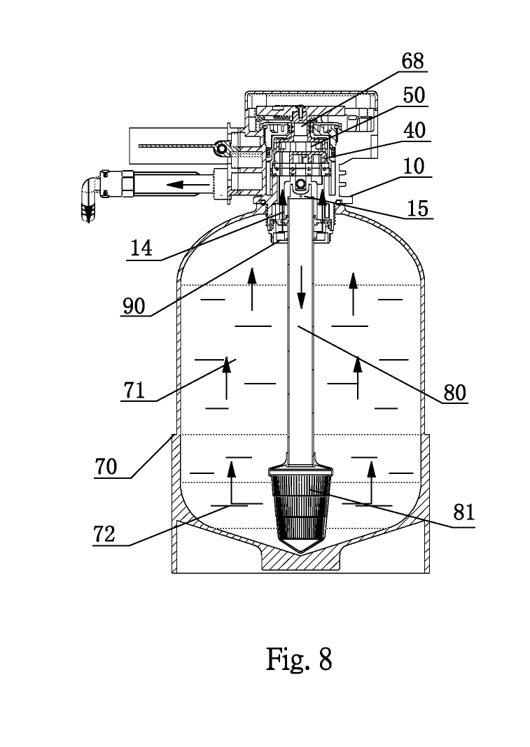

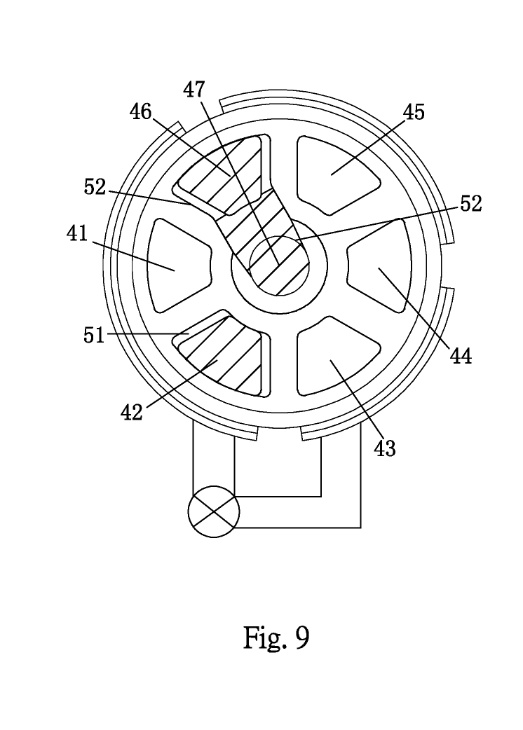

With reference to FIGS. 8 and 9, when the valve mechanism of the embodiment of the present invention is in a reverse cleaning phase, the dynamic valve plate 50 is rotated to a position where the aligning hole 51 is aligned with the second channel 42 of the static valve plate and the elongated blind hole 52 is aligned with the sixth channel 46, which allows water from the main inlet 11 passes through the inner channel 15, the central tube 80 and reaches to the distributor 81. After being filtered by the quartz sand 72 and the resin 71, waste water flows through the outer channel 14 and into the discharge 13 to be away from the valve mechanism of the preferred embodiment of the present invention.

Regenerating Phase (with the Electromagnetic Valve On)

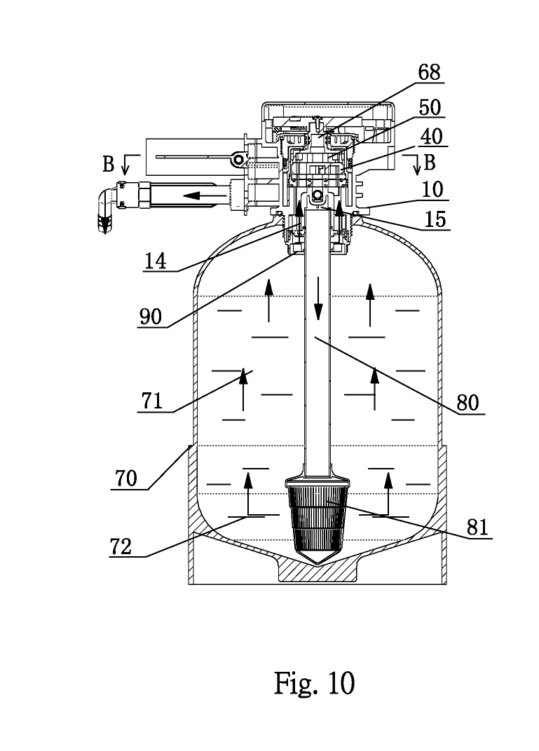

With reference to FIGS. 10˜12, when the valve mechanism of the embodiment of the present invention is in a regenerating phase, the dynamic valve plate 50 is rotated to a position where the aligning hole 51 aligns with the third passage 43 and the elongated blind hole 52 is aligned with the first passage 41. When the correlation between the static valve plate and the dynamic valve plate 50 is in the above status, water from the main inlet 11 flows through the ejection inlet 17 and the salt inlet 16, which allows the salt water inside the brine tank 110 to be sucked out of the brine tank 110 to mix with the water from the main inlet 11. After the salt water from the brine tank 110 is mixed with the water from the main inlet 11, the mixed water flows through the ejection outlet 18, the electromagnetic valve 30, the outer channel 15 and enters the resin tank 70. Inside the resin tank 70, the mixed water is then filtered by the resin 71 as well as the quartz sand 72 and exits from the discharge 13.

Water Supplementing Phase (with the Electromagnetic Valve Off)

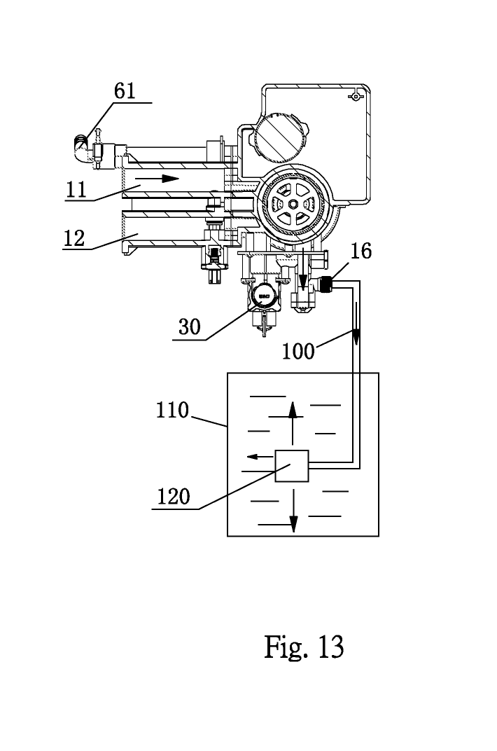

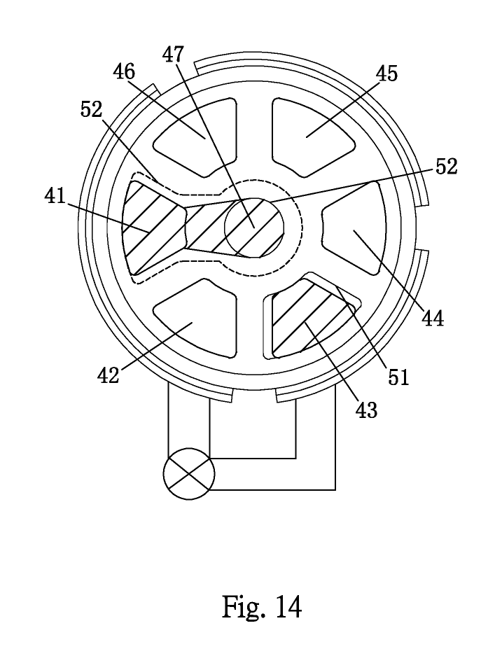

With reference to FIGS. 13 and 14, when the valve mechanism of the embodiment of the present invention is in a cleansing phase, the dynamic valve plate 50 is rotated to a position where the aligning hole 51 aligns and communicates with the third passage 43 which communicates with the ejection inlet 17 of the ejector 20 and the elongated blind hole 52 is aligned with the first passage 41, water from the main inlet 11 flows through the ejection inlet 17 and the salt inlet 16 to enter the brine tank 110 to finish the phase.

Cleansing Phase (with the Electromagnetic Valve Off)

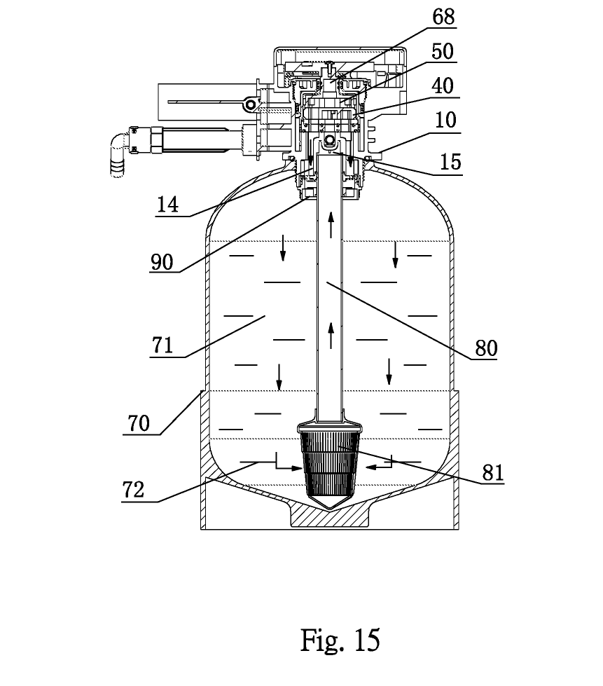

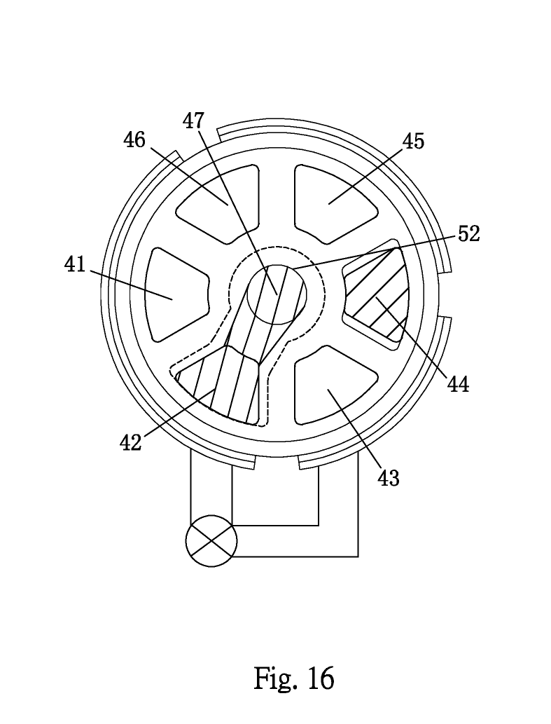

With reference to FIGS. 15 and 16, when the valve mechanism of the embodiment of the present invention is in a cleansing phase, the dynamic valve plate 50 is rotated to a position where the aligning hole 51 is aligned and communicating with the fourth passage 44 and the elongated blind hole 52 is on top of the second passage 42, water from the main inlet 11 passes the outer channel 14 and enters the resin tank 70. Thereafter, the water flows through the inner channel 15 and exits from the discharge 13.

After a detailed description of the preferred embodiment(s) has been provided, any skilled person in the art would easily understand the description so provided is for example purpose only. The scope for protection of the present invention is defined by the attached claims. Any skilled person in the art would easily amend, modify or alter the elements/devices of the present invention without departing from the principle essence and spirit of the present invention. However, the amendment, modification or alteration shall fall within the protection scope sought of the present invention.

What is claimed is:

1. A water softener valve mechanism comprising:
a body provided with a main inlet, a main outlet and a discharge, the body further having therein:
a static valve plate provided with a first passage, a second passage, a third passage, a fourth passage, a blind fifth passage and a sixth passage respectively and radially defined through a surface of the static valve plate and a seventh passage defined through a central portion of the static valve plate to have the first passage, the second passage, the third passage, the fourth passage, the blind fifth passage and the sixth passage radially located around the seventh passage; and
a dynamic plate rotatable relative to the static plate and having an elongated blind hole defined in a side face of the dynamic plate to allow a portion of which aligns with the seventh passage and remainder of which to selectively align with the blind fifth passage, the sixth passage, the first passage and the second passage and an aligning hole defined to selectively communicate with the first passage, the second passage, the third passage, the fourth passage and the sixth passage of the static valve plate; and
a driving device mounted inside the body to drive the dynamic valve plate to rotate.

2. The water softener valve mechanism as claimed in claim 1, wherein the driving device includes a step motor, a master gear securely connected to the step motor to be driven by the step motor to rotate, and a planetary gear meshed with the master gear to be driven by the master gear, the planetary gear is securely connected to the dynamic valve plate to provide a driving force to the dynamic valve plate to rotate relative to the static valve plate to allow the aligning hole to selectively and respectively align with the first passage, the second passage, the third passage, the fourth passage and the sixth passage of the static valve plate.

3. The water softener valve mechanism as claimed in claim 2 further having a plurality photo sensors mounted inside the body and pads mounted on the planetary gear to allow the photo sensors to detect angular positions of the dynamic valve plate after rotation.

4. A water softener system comprising:
a body having a main inlet, a main outlet, a discharge, a static valve plate immovably located inside the body and having a first passage, a second passage, a third passage, a fourth passage, a blind fifth passage, a sixth passage and a seventh passage radially defined through a face of the static valve plate and a dynamic valve plate rotatable relative to the static plate and having an aligning hole selectively communicating with the first passage, the second passage, the third passage, and the fourth passage and an elongated blind hole with a portion thereof aligned and communicating with the blind fifth passage, the sixth passage, the first passage, and the second passage while the other portion of which is aligned and communicating with the seventh passage of the static valve plate such that filtering phase, reverse phase, regenerating phase, cleansing phase and water supplementing phase are respectively processed via the correlation between the static valve plate and the dynamic valve plate.

5. The water softener system as claimed in claim 4 further comprising a driving device mounted inside the body to drive the dynamic valve plate to move.

6. The water softener system as claimed in claim 5, wherein the driving device includes a step motor, a master gear securely connected to the step motor to be rotatable relative to the step motor, and a planetary gear meshed with the master gear to be driven by the master gear, the planetary gear is securely connected to the dynamic valve plate to provide a driving force to the dynamic valve plate to rotate relative to the static valve plate.

7. The water softener system as claimed in claim 6 further having a plurality photo sensors mounted inside the body and pads mounted on the planetary gear to allow the photo sensors to detect angular positions of the dynamic valve plate after rotation.

8. The water softener system as claimed in claim 5, wherein the dynamic valve plate is rotated to a position to undergo a filtering phase, where the aligning hole is aligned and communicating with the first passage of the static valve plate and the elongated blind hole is aligned with the fifth passage of the static valve plate such that water from a main inlet is flowing through the aligning hole of the dynamic valve plate for entering a resin tank.

9. The water softener system as claimed in claim 5, wherein the dynamic valve plate is rotated to a position to undergo a reverse cleaning phase, where the aligning hole is aligned with the second channel of the static valve plate and the elongated blind hole is aligned with the sixth channel.

10. The water softener system as claimed in claim 5, wherein the dynamic valve plate is rotated to a position to undergo a water supplementing process, where the aligning hole aligns with the third passage and the elongated blind hole is aligned with the first passage.

11. The water softener system as claimed in claim 5, wherein the dynamic valve plate is rotated to a position to undergo a cleaning process, where the aligning hole aligns and communicates with the third passage and the elongated blind hole is aligned with the first passage.

12. The water softener system as claimed in claim 5, wherein the dynamic valve plate is rotated to a position to undergo a filtering process, where the aligning hole is aligned and communicating with the fourth passage and the elongated blind hole is on top of the second passage.

13. The water softener system as claimed in claim 8, wherein the dynamic valve plate is rotated to a position to undergo a reverse cleaning phase, where the aligning hole is aligned with the second channel of the static valve plate and the elongated blind hole is aligned with the sixth channel.

14. The water softener system as claimed in claim 9, wherein the dynamic valve plate is rotated to a position to undergo a regenerating process, where the aligning hole aligns with the third passage and the elongated blind hole is aligned with the first passage.

15. The water softener system as claimed in claim 10, wherein the dynamic valve plate is rotated to a position to undergo a water supplementing process, where the aligning hole aligns and communicates with the third passage and the elongated blind hole is aligned with the first passage.

16. The water softener system as claimed in claim 11, wherein the dynamic valve plate is rotated to a position to undergo a cleaning process, where t the aligning hole is aligned and communicating with the fourth passage and the elongated blind hole is on top of the second passage.
